(19) United States
(12) Patent Application Publication
(10) Pub. No.: US 2013/0332805 A1
(43) Pub. Date: Dec. 12, 2013

(54) SYSTEM AND METHOD FOR FACILITATING RENDERING OF ELECTRONIC BOOKS

(71) Applicant: Barnesandnoble.com IIc, New York, NY (US)

(72) Inventors: Lenox Brassell, Palo Alto, CA (US); Howard Campbell, Palo Alto, CA (US); Peter Farago, Palo Alto, CA (US); Ravi Gopalakrishnan, Palo Alto, CA (US); Simon Kent, Palo Alto, CA (US); Jim Lester, New York, NY (US); Will Manis, Palo Alto, CA (US); Roger Webster, Palo Alto, CA (US)

(21) Appl. No.: 13/911,928

(22) Filed: Jun. 6, 2013

Related U.S. Application Data
(60) Provisional application No. 61/656,248, filed on Jun. 6, 2012.
(60) Provisional application No. 61/656,267, filed on Jun. 6, 2012.

(51) Int. Cl. G06F 17/21

(52) U.S. Cl. CPC G06F 17/212
USPC 715/201

(57) ABSTRACT

The present application facilitates creation of electronic book files by defining and utilizing application programming interfaces to facilitate execution of scripts to facilitate display, execution, graphic icons, audio, and graphics, and any insertion of content into an electronic book format.

### FIELD OF THE INVENTION

The present invention relates to creating and facilitating electronic book publications with application programming interfaces and a book operating system.

### SUMMARY OF THE INVENTION

The present invention includes a system and for executing electronic book content on an electronic device having a display screen on which one or more pages of content is displayed. The electronic book comprised three principle parts a book file, an auxiliary file containing entity details and at least trigger based on a reference to a Canonical Fragment Identifier (“CFI”, hereafter), and a reference file that contains an index to the auxiliary file. Each of these files are stored in the memory of the electronic device, e.g., an e-book reading device.

As the electronic device executes the book file it utilizes the reference file as an index for the auxiliary file. The auxiliary file and the reference file are examined during this execution the trigger is executed when an associated CFI is visible on a current page as viewed by a user.

### BACKGROUND OF THE INVENTION

Electronic book readers have been warmly received by avid book readers worldwide and allow mobile access and portability of reading and viewing electronic books and publications (“e-books”, hereafter). One well established e-book standard, “EPUB,” is a free and open e-book standard by the International Digital Publishing Forum (IDPF).

Presently, electronic book and publication creators do not have standard application programming interfaces or any means to efficiently reuse or create e-books. For example, creators need to copy and paste scripts to create e-books.

### BRIEF DESCRIPTION OF THE DRAWINGS

The subject matter of the present invention is particularity pointed out and distinctly described in the present specification. The subject matter of the present invention, however, both as to organization and method of operation, together with objects, features, and advantages thereof, may best be understood by reference to the following detailed description when read with the accompanying drawings in which:

FIG. 1 is a system illustrating an embodiment of an electronic book file creation and delivery to an electronic book device;

FIG. 2 is a flowchart illustrating an embodiment of a method for electronic book file creation in accordance with the present invention;

FIGS. 3-12 depict several examples of screen shots of electronic books displayed and supporting reference files to allow for drawings, text, audio, and other content to be inserted and displayed in accordance with several embodiments of the present invention; and

FIG. 13 depicts an electronic device according to the present invention.

### DETAILED DESCRIPTION OF THE INVENTION

As previously discussed, electronic book and publication creators do not have standard application programming interfaces or any means to efficiently create and/or reuse the interactive elements of eBooks. For example, creators need to copy and paste scripts.

The present invention facilitates creation of interactive electronic book files by defining and utilizing application programming interfaces to facilitate execution of scripts to facilitate display, execution, graphic icons, audio, and graphics, and any insertion of content. In one embodiment, a generic electronic book in EPUB format is enhanced by utilizing an auxiliary file that is coupled to a particular book or publication.

Hyperlinking on the Web has been a large benefit to facilitate access to information. Unfortunately. EPUB publications have been denied much of the benefit that hyperlinking makes possible, primarily because of the lack of a standardized scheme to link into them.

Although proprietary schemes have been developed and implemented for individual reading systems, it is difficult to achieve cross-platform interoperability without a commonly understood syntax. Furthermore, the functionality that can see significant benefit from breaking down this barrier is varied. For example, functional improvements include reading location maintenance, annotation attachment, navigation, and the ability to point into any publication. These improvements open a new dimension not previously available to developers and authors.

One attempted solution is to define an arbitrary structural reference that uniquely identifies any location or simple range of locations in a publication. The EPUB Canonical Fragment Identifiers (“CFI”, hereafter) specification has been developed by IDPF.

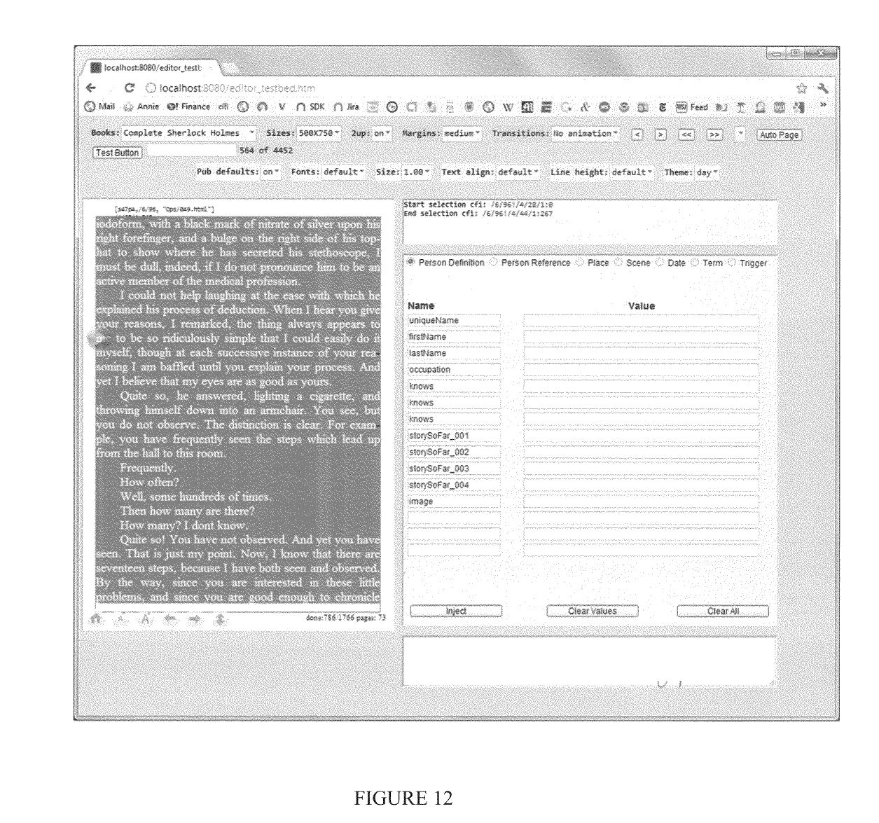

Presently, EPUB book files contain CFI. In one embodiment, the present invention utilizes an auxiliary file to contain information details that correlate to an index in a reference file. The auxiliary file may be in a .xml format and comprises CFI. Also, in another embodiment, the data may be represented as JavaScript Object Notation (JSON) with equivalent functionality. In one aspect, the CFI acts as “directions” to a particular point or range within the electronic book. For example, FIG. 12 depicts an associated CFI (on the right side) for the first and last characters of a displayed book page (on the left side).

Furthermore, the reference file, which also may be in an .xml format in one embodiment, is utilized as an index for the auxiliary file. Upon examination of both the reference file and the auxiliary file, a trigger could result when an associated CFI is visible on a current page as viewed by the user.

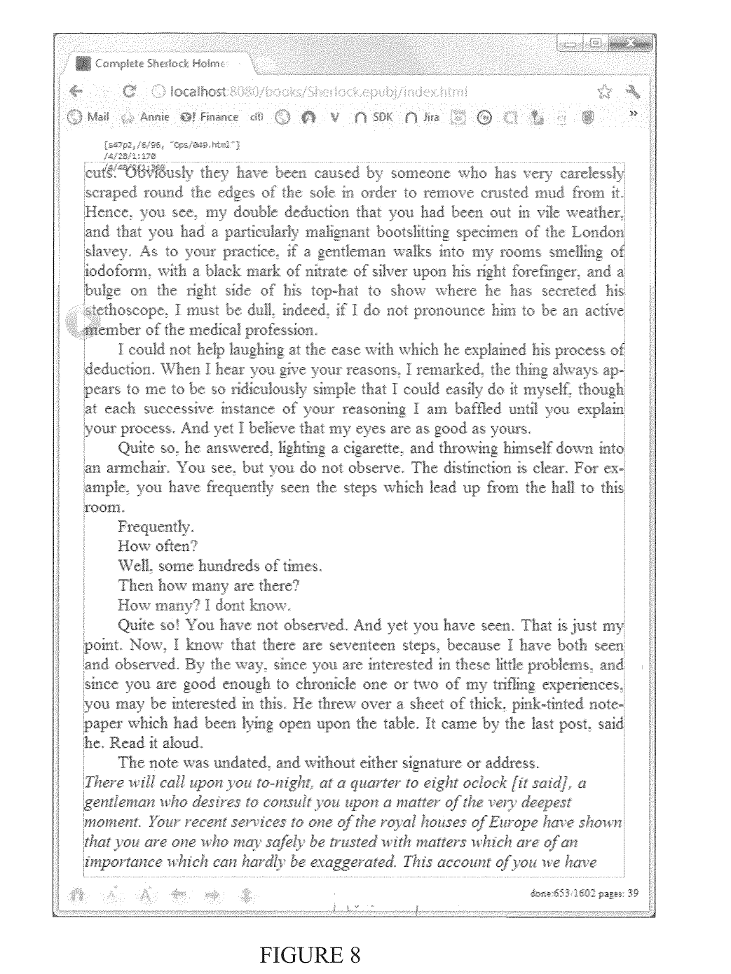

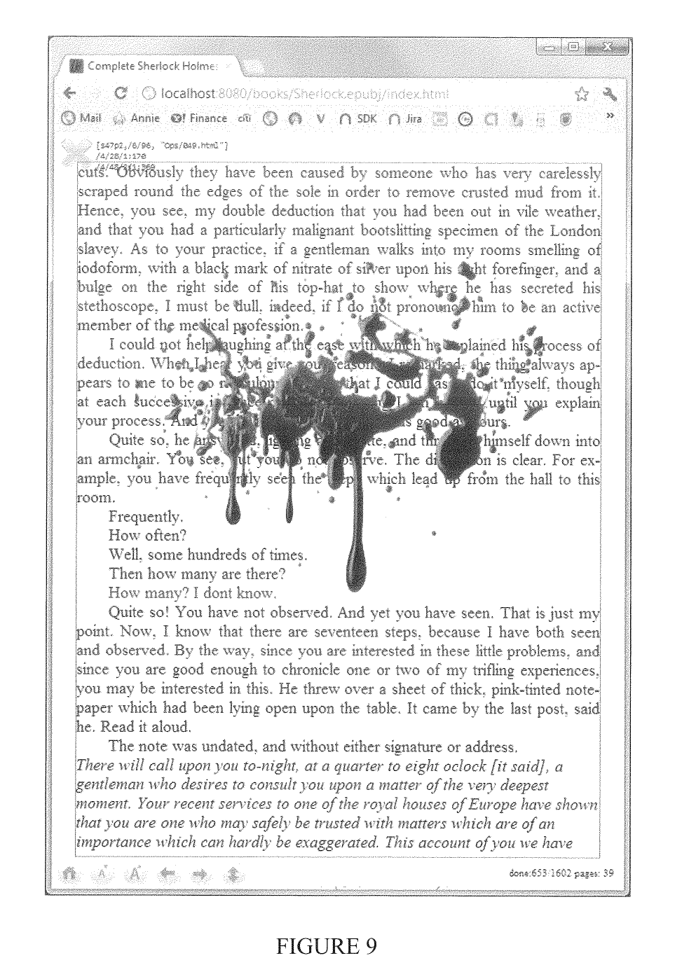

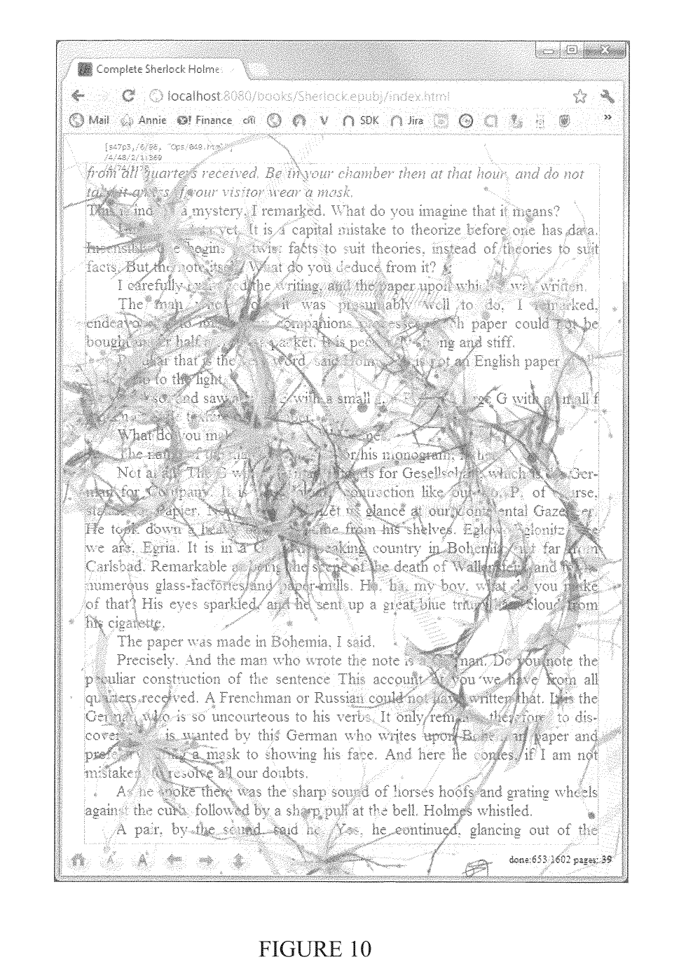

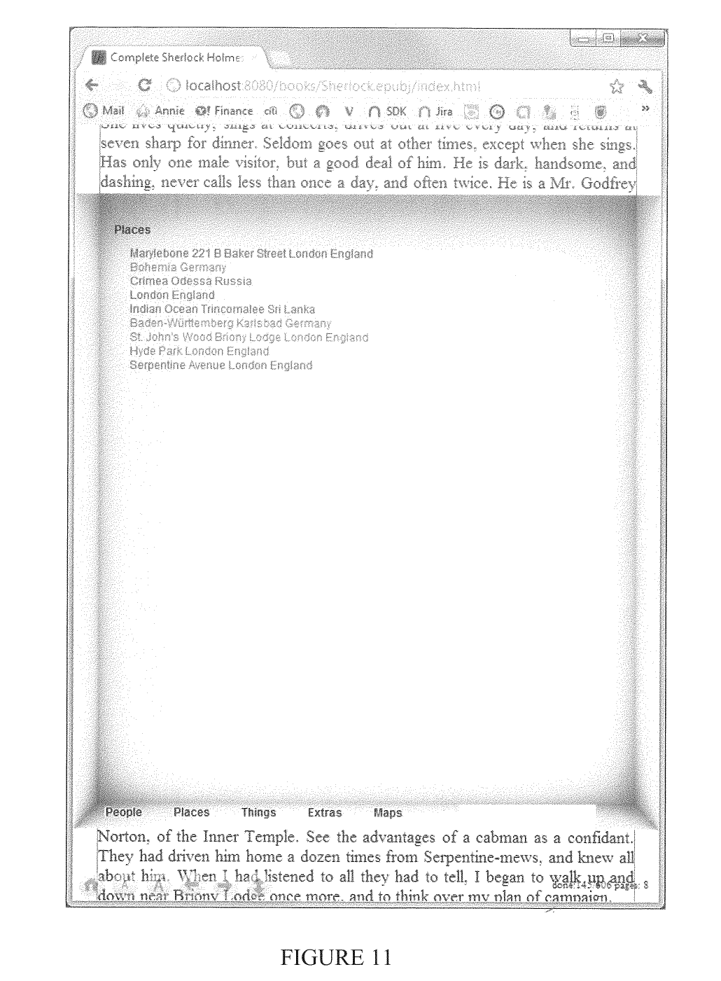

Consequently, the present invention facilitates executing a script, or loading a page, or playing a video underlay or overlay, animating via means other than scripting (Cascading Style Sheets (CSS) animations) or fading the content a page in or out, and that is displayed over, under, or to the side of the present page. For example, FIGS. 8-13 depict several examples of the resulting page upon executing the trigger.

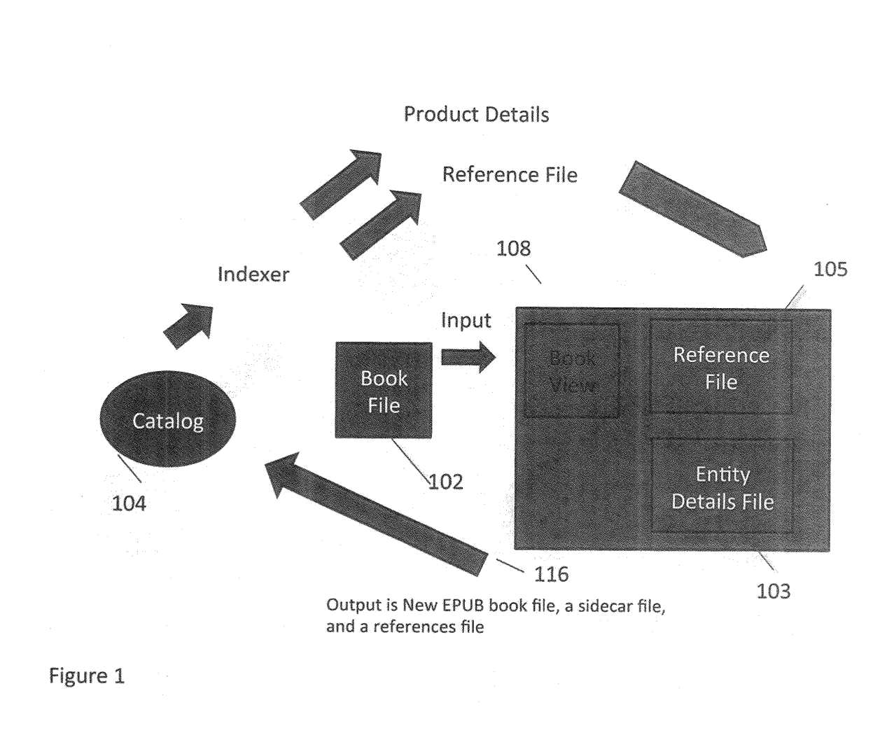

FIG. 1 is a system illustrating an embodiment of an electronic book file creation and delivery to an electronic book device. In this embodiment, a book file 102 in either a EPUB 2 or EPUB 3 format, is used as an input to a sidecar-creating package illustrated by 108. Also, a catalog 104 stores information that is used as an indexer that contains product details and a reference file 105. The reference file 105, an entity details file 103 and the book file 102 are used as inputs to the sidecar-creating package 108. The resulting output 116 of the sidecar creating package 108 are three artifacts (a new EPUB book file, a sidecar file, and a reference file) that are stored back into the catalog 104 and are subsequently loaded to a e-book reading device, cell phone, computer, or any device capable of displaying an e-book file.

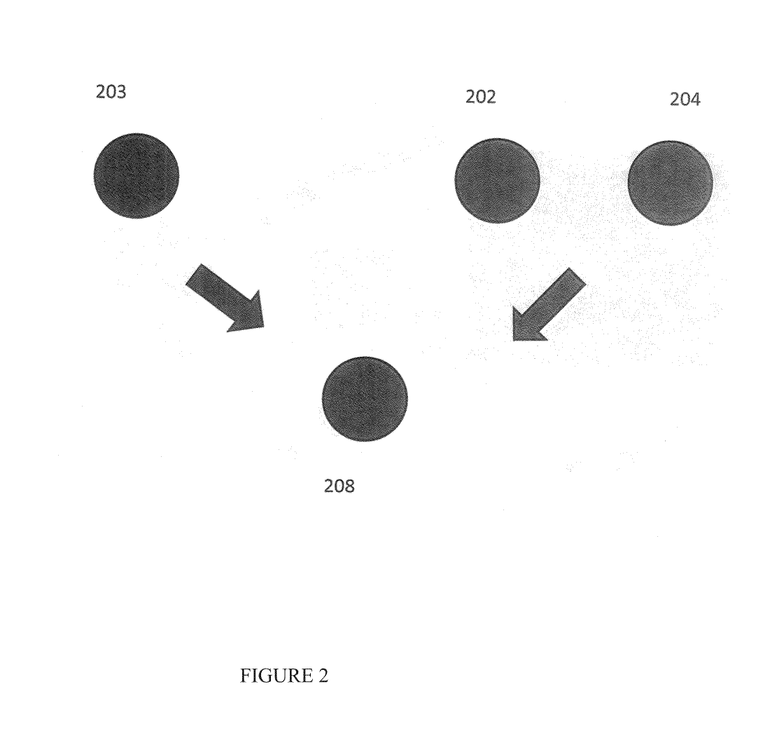

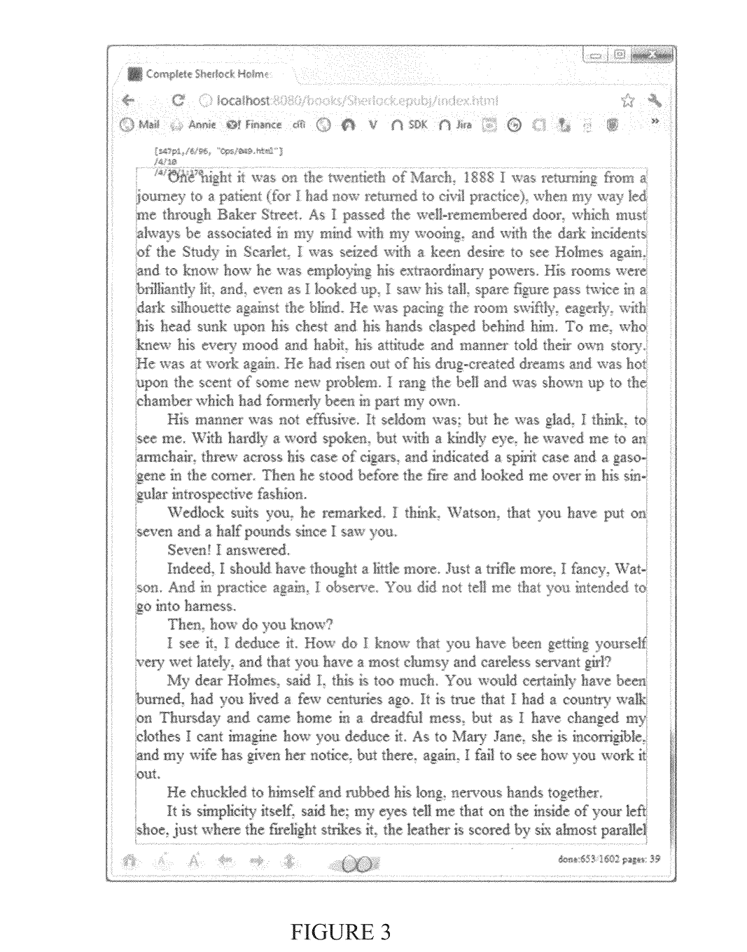

FIG. 2 is a flowchart illustrating an embodiment of a method for electronic book file creation in accordance with the present invention. In this flowchart, a book file in an EPUB format 208 is created based on an input auxiliary file 203 that contains entity details and a trigger based on a reference to a CFI. In one embodiment, the auxiliary file 203 contains the entity details and references. In another embodiment, there is a separate auxiliary file 202 and a separate reference file 204. The resulting EPUB format allows for a script or execution of an event based on the trigger that results in a window display near the trigger point in the book view that displays an image, sound, information, etc. Several examples are depicted later in this specification to illustrate the examples. Also, the present invention supports rendering of a EPUB book format that complies with EPUB 2 or EPUB 3 formats.

Table 1 depicts several pages of an auxiliary file, as utilized by an embodiment to contain information details that correlate to an index in a reference file as shown in Table 2.

```
TABLE 1
<xml version =1.0 encoding=”UTF-8”?>
<sidecar I•‘c•“http://www.nook.com/sidecar”>
<1-. content-specif1c BtB tabs, including overrides of defaul is (People) ..•··>
<~~:tabExtras>
<t:tab < ln • http://www.nook.co./tabDefinition”>
<t:caption>People</t.capT1on>
<!-- If you want a subset of all possible entities, matchTag lets you select a single entity kind. ··>
<matchTag> character </t: .matchTag>
<t:file>OEBPS/ html/people . html</t:file>
</t:tab>
<t:tab In •“http://www.nook.com/tabDefinition” >
<t:caption>Maps</t:caption>
<! .. If you DON'T want a subset of all possible e ntities, you must use a “*” for a wildcard. Cannot be empty . . • ··,
<t:matchTag> •</t:matchTug>
<t:fil~>OEBPS/html/NapsTag . html </t:file>
</t:tab>
<t:removeDefaultTab>
<t:captlon> Thines </t:c~plion>
</t:removeOcf~ultT~b>
<l‘>c: t ullFxt ras>
<I·· Events and handlers •.•-·>
<~c:<criptfxtr~s>
<S:~cript 1 ‘ •“http://www.nook.co./eventActions” >
<s:file>OEBPS/scripts/onLoadScript.js </s:file>
<s:event>onBookOpen</s:event>
<s:classConstrurtor>nook.BookOS. LoadSample </s:classConstructor>
<~;~tartMethod> start </s:startMethod>
<s:sto~~thod> halt </s:stop~ethod>
</s:script>
<S:script • •“http://www.nook .COM/eventActiOnS” >
<s:fJie>OEBPS/scripts/onPageTurnScript.js </s:file>
<s:event>onPageTurn</s:event>
<s:classConstructor> nook.BookOS.PageTurnsample </s:clu~sConslructor>
<s:startMethod> start</~:start~~thod>
<s: stopl‘.pthod> halt< /s: stop~lethod>
</s:scl“ipt>
<s:IHML ‘ “’”S;“http://www.nook.com/eventActions” >
<s:file>OEBPS/scripts/onPageTurnHTHL.html </>:tile>
<s:~v~nt>onPageTurn</s:event>
</s:HTMI >
</~c:striplExtras>
<I-- Chet‘iietet” identity map ... -->
<SC:(‘Ill ityM,1pExlo’.JS>
<nm:names ‘onlns t“-”http://www.nook.com/namel’lap” >
<nm:friendlyName>Sherlock Holmes </nm:friendlyNam~>
<nm:idEntry>holmes</nm:idEntry>
</nm:namf’~>
<nm nJmes X< J > • “http://www.nook.com/naoneMap”>
<nm:frien~lyName> Irene Adler</nm:friendlyNdme>
<nm:idEntry>adler</nm:idEntry>
</nm: name_,
<n ·naooes “”“ ‘ :• “http://www.nook.com/name’lap”>
<nm·friendlyNa~e> John Watson <i~:~riendlyNJ~>
<n•:idEnt•y>watson</nm:idEntry>
</l‘llll:na .. f’s>
<n,:names x l·• • ‘http://h‘WW.nook.ceo~/nall’el’lap”>
<nm:friendlyNa~e> Mary lane Watson </nm:friendlyNdTC>
<nm:idEntry>•aryjane</n~:id£ntry>
</nm:nal!\es><nm:names <mhs ~“‘~“http.//www.oook.com/nameMap” >
<nm:f~iendlyName> Count Von KraiMI </nm· fdt>ndly~ame>
<nm:idEntry> kramm</nm.ldEntry>
</nm:names>
<nm:narres mln- “•“http.//www. nook.com/nameMap” >
<nm: friendlyNa e>Clothilde Lothlman </1“‘: frumdlyNarre>
<nm:;cEntry> clothilde</~·idontry>
</nm:names>
<M:names x <“‘ •“http //www.nook.com/namel’lap” >
<nm:friendlyName>Godfrey Norton</nm:friendlyName>
<nm:idEntry> norton</nm:idEntry>
</nm:names>
<nm: nam<>s x•lr ‘ r • “http: //www.nook.com/naiOeMap·’ >
<n~:friendly~a~> bakerstreet</nm:friendlyName>
<n~:idEntry> bakerstreet <tnm tdEntry>
</nro:na~es>
<nm:names •• .~ = “http://www.nook.com/namcl‘l~p” >
<nm: friendl yName> boheMia </n•n: friend! yNamP>
<nm: io;[ ntry> bohemia< /nm: idEntr’y>
</nm:names>
<nr·:names x .~~ r - “http·/1-...nook.com/ndmeHap”>
<nm:friendlyNdme>carlsbad</nm:friendlyNam<>>
<rm:idEnt“y>carlsbad</rm:idEnty>
</M>:na‘IIE!S>
<nm:na~es min• r •“http://www.oook.com/nameMap” >
<n•n : friendlyNa‘lle> briony</nm: friendlyN.JmC>
<nm: idEntry>briony</nrn: ldEntry>
</nm:names>
<nm:names xmln‘“‘• “http://www.nook.com/namel’lap”>
<nm:friendlyNa~e > serpentine</n•:friendly~ame>
<nm:ioEntry> serpentine</mn:idEntry>
</nm: names>
<n“‘·names • •“http://www.nook.com/nameMap• >
<nm: friendlyName> serpentineavenue</nm: friendlyname>
<nm:idEntry>serpentineavenue</nm:idEntry>
</nm:names>
</sc:entityMapExtras>
<!-- Characters ... -->
<sc rhar~cterExtras>
<scLextr-a>
<ent :character “‘•“http://www.nook.cOM/entity” •J=“holmes”>
<ent:fir~tNa~e> Sherlock</ent:flrst\a~e>
<ent: lastNal“c> Holmes </ent: lastNall’e>
<ent:occupation> Consulting Detective</ent:occupation>
<!•• “Knows” - minimal relationship graph info. - ->
<ent: knm<s> adler</ent: knows>
<cnt : kno.<s> Watson</ent: kno>~s>
<ent: ill‘age>holmes.png</ent:irrage>
</ent:character>
<!-- list of locations in the book and incrementally revealed knowledge about the character at that location
(CF!) . -·>
<dir: storyBuilder <ml n h ~~“http://www. nook. com/directives”>
<dir:revealStory>
<dir:revealPoinl>epubcfi(/6/981/4/194/1:345) </dir:revcdlPoint>
<dir:revealText>Not a doctor. </dir·revealText>
</dir:revealStory>
<dir:revealStory>
<dir:revealPoint>epubcfi(/6/98!/4/184/1:345) </oir:revea\Polnt>
<dir:revealText>Knows anatoMy and chemistry. </dir:revealText>
</dir:revea\Story>
<dir:revealStory>
<di ,, : r•eveoJlPoint> epubefi(/6/981/4/194/1: 345) </dir: revealPolnt ><~ir·: revealText>Moves into 221 8 Baker
Street with Dr. watson. </eli r. “‘CvcalText>
</dir:revealStory>
</dir · storyllui lei<••·>
</sc:extr·d>
<SC:PX't~”−t:l)
<!-- General character info . Extensible. - ->
<ent: character 1 ,. r t;“http: //www. nook. co .. / entity” .L<• ’“adler” >
<~nt.firstNu~e> Irene </ent:tir>tNa~e>
<ent:last~a~e>Adler</ent:lastNa·e>
<ent:occupation>Opera Singer< /ent:occup·tion>
<ent:knows>holiM!S</ent.k.nows>
<ent:kno~s> norton</ent:knows>
<ent:image>adler.png</en•:image>
</ent:char.leter->
<!--This character is only valid (“visible”) i n t hese ranges ... ··>
<ref :validRanges ‘r; “http://““””’- nook. COOl/references··>
<rP r: rangP>
<ret: slclrt>epubcfi(/6/961/4/2/4/2/1 :e) </rPf: star·t>
<ref:end>epubcfi(/6/100!/4/92/1:322) </ref·end>
</ref.ran&P>
</ref.validRanges>
</sc:extra>
<sc:extra>
<ent:cha•acter ; “http://-.nook.cooo/entity” 1 e“watson”>
cent·fir<tName> John </ent:firstNa~>
<ent:lastNa~e>Watson</ent:lastNa~e>
<ent:orcupation>Artny Doctor, retired </ent:occupation>
<ent:kllo><~> holllles </ent:knows>
<ent:image>watson.png</ent:image>
</ent:rharact~r>
<dir: storyBuilder ,noJ ns rh -~ “‘http://www. nook. com/directives”’>
<dir:revealStory>
<dir: r·evealPoint/ >
<dir:revealTeXt>Lives at 221 8 Baker Street with Holmes. </dir:revealText>
</dir:rrvpalSto~y>
</dir.storyBuilder>
</sc :extra>
<sc:extra>
<ent :character • ~ ·‘http://www. nook. COlli/ entity” •’: “maryjane” >
<ent:fir~tN~me> Mary Jane</ent:firstName>
<ent:lastName>Watson</ent :lastName>
<ent:rt>lat~d lo>
<ent:characteriD>~<atson </ent:characteriD>
<ent: relationship>daughter</Pnt: rl'I.J I ion~hlp>
</ent:relatPdTo>
<enl:know~> watson </ent:knows>
</ent:character>
</sc:Pxtra>
<sc:extra>
<ent :chdrdeter· t • “http://WWiol. nook. COli/entity” · c. : “kra!M”>
<ent:first~a~e> Count </ent:first\a~e>
<ent:last~~e>Von Kran.cfent:ldsl~d•e>
<ent occupation> BoheMian Nobleman</ent:occupation>
<ent:knows>ormstein</ent:krows>
</ent:charactrr>
<dir: storyBuilder x‘~’ cllr ~“http : 1/www. nook. com/directives”’>
<dir: r~vco~ 1 <;tor·y>
<dir:revealPoint/>
<dir:reveaiTPxt>l4earing a mask, does not want true identity known. </dir:revealText>
</d i r•: r<‘VC~1 Story>
<dlr:reveal Story>
<du•: revedlPoint/ >
<dir:revealText>Actually the King of Bohemia</dir:revealText>
</dir:rpvpalStory></dir:storyBuilder>
</sc:extra><<c::Pxtra>
<ent:Chdracte‘“ •nt=“http://www.nnok.CC)I!I/entity” 1 e“clothilde”>
<ent:firstName> Clothilde </Prt:f•r~tNane>
<ent:lastNa~> Lothman </ent:.astNome>
cent:occupatioi1>Clotilde Lothman von Saxe-Meningen, second daughter of the King of Scandinavia
</ent:octup~llOn>
<ent:knows> kramm</ent:kno~>~s>
</ent:character>
</sc:extra>
esc: extra>
<Pnt: character ot c“http://www. nook. coce/entity•• .• ”norton• >
cent:firstNa~> Godfrey</ent:firstNamP>
cent: lastName>Norton</ent: la~t'l.ltne>
<ent:occupatlon> Lawyer</ent:occ~pdtion>
<ent:knows>adler</ent: knows>
<lent: charat t c••>
</S<: extr~ >
</\c :rharacterExtras>
c!-- Places .•• TODO: settle on canoni cal !1st of tags. -->
<sc:pl~rp<xtras>
<~ c ·extra>
<cnt:place l, t•‘http://~~.nook.coce/enlity” lC=“bakerstreet”>
cent: country>England</ent: countr·y>
cent : city>London c/c•nt: city>
cent:streetAcfclress>221 B Baker Street </ent:streetAddr·~ss>
cent:dblrict>Marylebonec/ent:distri.ct>
cent: image>baker.jpg</ent: image>
</ent:place>
</sc:extra>
esc. extra>
<ent:place !t•“http.//www.nook CON/entity” ld= “bohemi~”>
<ent:country>Germany<ent:country>
cent:region>Bohemia</ent :reg ion>
</ent:place>
</sc :extra>
<sc: extra>
<ent:place rln· ~t~“http:// ........ nook.coao/entity” 1o ~“odessa”>
<ent:courtry>Russia</ent:country>
<ent:city>Odessa</cnt :city>
cent:~gion> Cri~a c/ent:region>
cent:image>odessa.jpg</ent:image>
</ent :place>
</sc:extra>
esc: extra>
<ent: place ., “ N t •“http: //www. nook. com/entity” Hl • “london” >
<ent:country>England</ent:country>
<ent:city>London</enr:city>
</ent:place>
</sc.extra>
<$c: extra>
<ent: place xnllt < o't~“http://www.nook. com/entity” id=“trincomalee”>
<ent :country>Sri Lanka</cnt:country>
cent :city>Trincomalee<{ent:city>
<ent:reeion> Indian Ocean</ent:region>
</ent:pldce>
</~‘:extra>
esc: extra>
<ent:plate • 1 •• • “http://www. nook .coll/entity” id; “carlsbad”>
cent:country>Germany</ent:country>
cent:city>Karlsbad</ent:city>
cent: region> Baden-WUrttemberg</cnt: r'egion>
</ent :place>
</sc :extra>
<~c:extra>
            <ent:place lr.< ent•“http://www.nook. cOII/entity” id=“briony”>•ent •tourot y>
            England</ent.cou'lt”Y>
            <Pntrlry>london</ nt:city>
            <ent:sueet>Briony Lodge</ent:street>
            <e11t.r'r>gto11>St. John's Wood</l!rrt:r giorr>
        </ent place>
      </sc:cxtr· >
      <:.(.:exlrct>
        <Pnt. piMf [symbol]    “htlp://www:nQOlc.cooo/entity − · erpentine•>
            <ent:country> England </ent:count y>
            <crt Oty> London •/ent · city>
            <ent egion Hyde Pak<Jent:regioo>
        </ent pl < >
      <I sc:eXTra>
      <sc:extr >
        <entplace ,• “t•“http//WI <W.nook .eM/entity” d•“serpentineavenue•>
            <eM.murrtry>England</entcounLr·y>
            <ent city>London</ent:city>
            <cnl st rc<:OScrpentine Avenue </ent. street>
        </ent:placE”>
      </scexlt'ol>
    </sc placeExtra >
    <!-- Dates.. -->
    <§<::dat,Ext“ra>
      <SC:extra>
        <ent:date  •http://www.nook.ca./entity”>
            <ent·ypar>1888</ent year>
            <ent:month> 3</ent:month>
            <Pnt:day>29</Pnt:day>
        </ent:date>
      </sc:extr >
    </$C:dateExtras>
    < ! -- Terms ... -·>
    <sc:termExt,.as>
      <sc.·extrct>
        <,.nt:tp,.,lnfo  I•  t, “http://._.nook.ca./entity”>
      <er.t:ter•b ougham</ent:tena>
      cent ccscrlptl t> A two-door,four-wheel,ho se-d awn carriage.</ent dPsc,.tptlon>
        </ent·ter'IIIrrfo>
      </sc·ertr,n
      <.SC ·e>tll
      d)
        <ent ·terrr,rllfn  •lr  n“=”http://www.nookcom/en lly” >
            <ent:term>freemason</ent:term>
            <ent:dc>tf'ption>Fr'aterna 1 organization with obscure origins. <lent:description>
        </ent:terll fnfo>
      </sc:extf.l>
      < c:e:tlt•d>
        <ent:tPNnTnfn  r •“http://WioiW.nookcom/entity”>
          <nl:t rm>chubb</ent:term>
          <l‘nt.rlP n·lption>A type of lock made by Chubb Locks of England. </en::c::escrtption>
        </ent:terll fnfo>
</sc:extra>
<sc:extro>
<ent:tPrmTnfo “‘ pf; “http://-.nook.com/entity”>
<ent:term>s urpli ce</ent:term>
<~nt:d~scription> For clergy, a tunic of white linen or cotton fabric , reaching to t he knees or to the
ankles, with wide or moderately wide sleeves. </ent:descl'iption>
</ent :termlnfo>
</sc :extra>
</sc:termExtras>
<! -- Triggers ... as in (for example) when t he associated CFI is visible on a the current -->
<! -- page, run a script/load a page, etc., either over the book or under it . ·->
<sc:triggerExtra>>
<sc:extra>
<ent:trigger ~ lrs er ; “http://. .... -w.nook.cOftl/entity”><~nt:ovPrl~y> true</ent:overlay>
<ent:autoPlay> false </ent:au~oPlay>
<ent:icen>playOVerlay.png</ent·icon>
<ent~i~etype> application/x- javascript </ent:•inetype>
<ent:op~city> 0<tent·opacity>
<Pnt: file>OEBPS/script/RogOverlay. js <lent: fil<>>
<ent:clas<Constructor> nook.BookOS.OVerlaySample </Pnt:~l~~sConstructor>
<ent: startmethod> initialize </ent: ~ldrtMethod>
<ent:stopMethod> halt</Pnt:stopMethod>
</ent :trigger
<~ef: references 1 <•“http ://www. nook .com/references”>
<ref:reference>epubcfi(/6/96!/4/66/1:279)</ref:referenceP>
</‘ef:referenceP~>
</sc·extra>
<sc: extra>
<(‘nt: trigger l•“‘ • “http: 1 /www. nook. COil’/entity” >
<ent:overlay>false </ent:overlay>
<ent:mimPtyp!’>application/xhtml</ent:mimetype>
<ent:opacity>0</Pnt·opJcity>
<ent:file>OEBPS/ht•l/RogOverlay.html </ent·file>
</ent:trigger’>
<rpf: reference~ • “http: I,......,... nook. coro/references • >
<ref:reference>epubcfi(/6/96!/4/24/1:68) </ref:rPreference>
</~ef:refPrPOCP~)
</~c:extra>
<5c:extra>
<ent :trigger > .liH’ t •“http://wo.:w.nook.com/tntity”>
<ent:overlay> true </ent:overlay>
<ent: autoPl ay> false < /ent : autoPlay>
<ent:icon>OEBPS/image/play.png</ent:lcon>
<ent :•iMetype>application/xhtllll < /ent :“‘u•ctype>
<ert:opacity>0</ent:opacity>
<ent:file>OEBPS/html/BloodDripsl.ht•l</ent;file>
</ent: t rigger>
<ref: references xr•l n <’f • “http: I /www. nook. com/references”>
<ref : reference>epubcfi(/6/96!/4/44/1:170) </ref:reference>
</ref:references>
</~c: extra>
</sc triggerExtras>
<1 ·- Content mutation ... -·>
<sc:mutationExtras>
<sc:extra>
<mut: ll'utution •l•· nut •“http:// ..‘W W.nook. com/mutations”>
<mut: addCunlenl>
<p> This is an entirely new paragraph </p>
</mut:addContent>
< /mut :ll'utation>
<!·· Reference is to the block (paragraph or something similar) ··>
<!-· before which the new content should be added. Note that -·>
<!-· CFIs have a side bias we should use. ·->
<rPf: references to“http :/ /www. nook. com/references”>
<ref:reference> cpubcfi(/6/96!/4/12/1:0) </ref :referencP>
</ref :references>
<I><: exlra>
<~c·extra>
<mut::otutation ‘ I • “http://,.‘W’.,.nook.com/mutations• >
<mut:MOdifyStyle> display:none </mut:~difyStyle>
< /mut: 111Ut I on>
<!-· Reference is to block·level node where this style should be applied. -->
<ref: reference~ “” =“http: I /www.nook. COOI1/references” >
<ref:reference>epubefi(6/961/4/12) </rpf:reference>
</ref: refer'ence~>
</sc:extra>
</sc:mutationExtras>
      < [symbol] >
      < [symbol] >
        < [symbol] >
            < [symbol] >
                < [symbol] [symbol] >
                < [symbol] /DEBPS/script/recipeMandler.js</ [symbol] >
            </ [symbol] >
        </ [symbol] >
      </ [symbol] >
      < [symbol] >
        < [symbol] > [symbol] [symbol]
            >
                < [symbol] file>DEBPS/script/myCake.rml</ [symbol] file>
                </ [symbol] >
            < [symbol] >
                < [symbol] epubcfi(/6/981/4/70/1:421)</ref:reference>
            </ref:reference>
        </ [symbol] >
      </ [symbol] >
  < [symbol] > [symbol]
indicates data missing or illegible when filed
```

Table 2 depicts two pages of a reference file that is utilized as an index for the auxiliary file depicted in Table 1;

```
TABLE 2
  xal  •“1 e·
<references
  <I - Characters -->

[symbol]

•UTF-8”’
      <charilctPr
        <character·
          <name>Sherlock Holmes</name>
          <rt'f rences>
            <rf'h•r·pnrr·>epubcfi(/6/98!/4/194/1:345) <Ire [symbol] erencP>
            <referPncP>epubcfi(6/96!/4/2/4/2/1:28}</reference>
            <reference>epubcfi(/6/96!/4/6/1:3)</reference>
            <reference epubcfi(/6/961/4/8/121<)in>f″″″″’,.,
          </r'C'frr·•nc
        </Character>”
        <!--General character info. Extensible.-·> Character•
          <nil••(>>Irene Adler</name>
          <referenceP\>
            c \reference>epubcfi(/6/981/4/46/1:231)</reference>
            <reference>epubcfi(/6/981/4/74/1295)</reh•rr•m<·>
            <r· tct· [symbol] :n [symbol] ||>epubcfi(6/981/4/28/1:12)</refe [symbol] pnr.c>
            <rt>fPr·r••H f [symbol] Cpubcfi(/6/96!/4/124/1:148)</reference>
            <reference>epubcfi(/6/961/4/208/1:4)</reference>PUSH [symbol]
            reference>epubcfi:(/6/96!/4/6/1:35)</reference>
            <reference>epubcfi(6/961/4/6/1:1175)<tref0·renn•>
          </rpfPf″f′Ot [symbol] >
        </character>r>
        <character>
          <n [symbol] >John Watson in;, e>
          crefp•pn pq
            <reference>epubcfi(/6/98!/4/54/1:76)</reference
            <reference>epubcfi(/6/96!/4/14/1:41)</r·fert:r•ce>
            <reference>epubcfi(/6/961/4/8/1:1)</r(‘ferpnrc>
          </“t’f(‘rt•Ot<O’>
        </character>
        character->
          <na••>Count Von Kramm</naiiC>
          <reference<>
            <reference >epubcfi(/6/96!/4/94/1:27)</reference>
            <reference>epubcfi(/6/96!/4/214/1:68)</reference>
          <I references>
        </character> [symbol]
        haracter
          <name>Clothilde Lothman </name>
          <rdcr· nce>
            <rl'fPI'f'mc•>epubcfi(/6/96!/4/198/13)</reference>
          </reference >
        <character>
        <char·H [symbol] ,..,..,
          <name>Godfrey Norton</name>
          <references>
            <reference>epubcfi(/6/981/4/38/1:594)</r-reference>
            <reference>epubcfi(/6/981/4/46/1:257)</refer!‘niP>
            <reference•>epubcfi(/6/98!/4/24/1S}</reference>
            <reference>epubcfi(/6/98!/4/22/1:464)</reference>
          /references
        <tcl>aracte >
        <c ar-.ac Pr>
          <nare>Roger Webster</n... >
          <references>
            <refer-ence>epubcfi(/6/981/4/38/1:594)<1reference.,
            <t‘l’ [symbol] <‘nr<’> epubcfi(/6/98/!4/46/1257)</reference>
            <reference<‘>epubcfi(/6/98!/4/24/1:5)</reference>
            <reference>epubcfi(/6/98!/4/22/1:464)</reference>
          </reference•
        </character>
      </characters>
  < [symbol]
  < [symbol]
  < [symbol]
    <place>
      < [symbol] >baker street [symbol]
      <references>
        < [symbol] epubcfi(/6/98!/4/136/1:48)</reference>
      </references>
    </place>
    <place>
      < [symbol]
      21 references>
        <references>epubcfi(/6/98!/4/68/1:23)</reference>
      </references>
    </place>
    <place>
      < [symbol] >carlsbad</ [symbol]
      <reference>
        <reference>epubcfi(/6/96!/4/66/1:399)</reference>
      </references>
    </place>
    <place>
      < [symbol] >bri [symbol] </ [symbol]
      <references>
        <reference<epubcfi(/6/98!/4/222/1:9)</reference>
        <reference>epubcfi(/6/98!/4/106/1:249)</reference>
      </references>
    </place>
    <place>
      < [symbol] serpentine [symbol]
      </references>
        <reference>epubcfi(/6/68!/4/22/1:126)</reference>
      </references>
    </place>
    <place>
      <serpinetineavenue [symbol]
      <references>
        < [symbol] epubcfi(/6/98!/4/306/1:128)</reference>
      </references>
    </place>
  </place>
</references> [symbol]
indicates data missing or illegible when filed
```

Table 1 depicts several pages of an auxiliary file, as utilized by an embodiment to contain information details that correlate to an index in a reference file as shown in Table 2. As discussed earlier, the present invention creates and utilizes an auxiliary file to contain information details that correlate to an index in a reference file. The auxiliary file may be in a .xml format and comprises CFI. In one aspect, the CFI acts as “directions” to a particular point or range within the electronic book. For example, FIG. 12 depicts an associated CFI (on the right side) for the first and last characters of a displayed book page (on the left side).

In Table 1, which depicts an embodiment of an auxiliary file which is in a XML file format, contains the information entity details, various scripts that may be enabled, used, configured, or referenced, names of characters in the book, settings, and trigger points for when an associated CFI is visible on a current page to initiate or run a script to load a page and display.

One skilled in the art appreciates and understands the syntax depicted in the XML format. Nonetheless, the following explanation will articulate the portions of the Figure for ease of the audience.

In Table 1, a brief summary of content specific tabs is listed along with an identity map for several characters. Table 1 additionally depicts a list of locations that are in the book that incrementally reveal knowledge about the character at that associated location based on the CFI.

In one embodiment, the default tabs are available. For example, for a fiction story, people, places and terms could be default tabs. For other types of stories, one may utilize other types of default tabs.

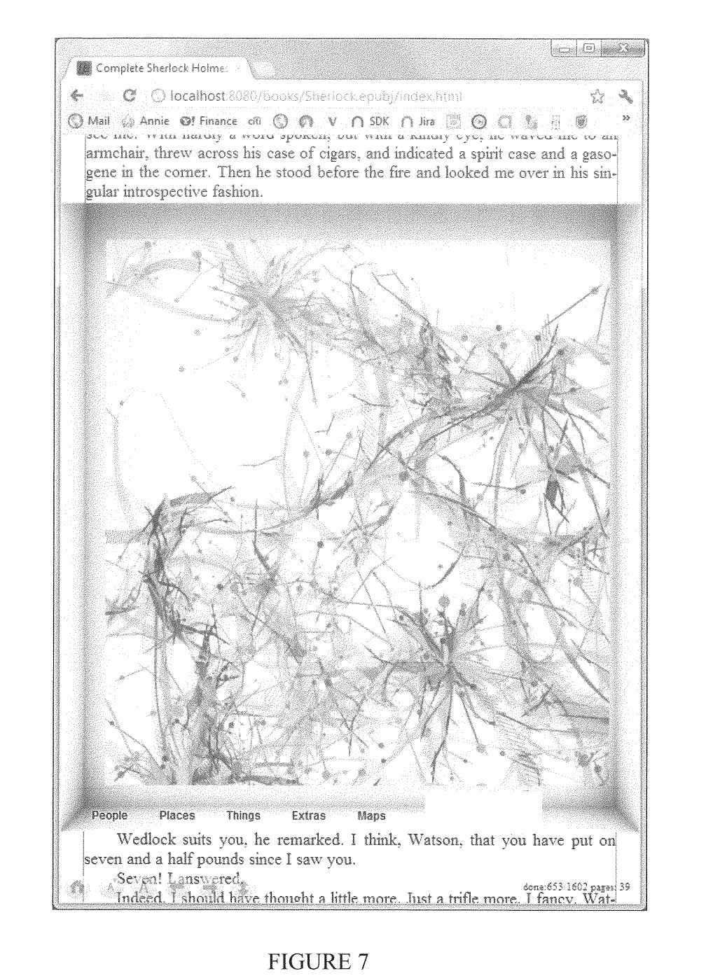

In Table 1, a list of trigger points is depicted . As discussed earlier, the trigger points are used when an associated CFI is visible on a current page to initiate or run a script to load a page and display. For example in the depicted embodiment for the first trigger point, an icon “playOverlay.png” is defined and a script file “OEBPS/script/RogOverlay.js” is initiated upon the trigger being set when the associated CFI is visible on the current page. Consequently, an icon for a play button might be displayed for this embodiment (as depicted in FIG. 8). Alternatively, a graphics image might be superimposed onto the text (as depicted in FIGS. 7, 9, and 10). In yet another embodiment, a window display is created above, below, or to the side of the book view that displays additional character, setting, etc.

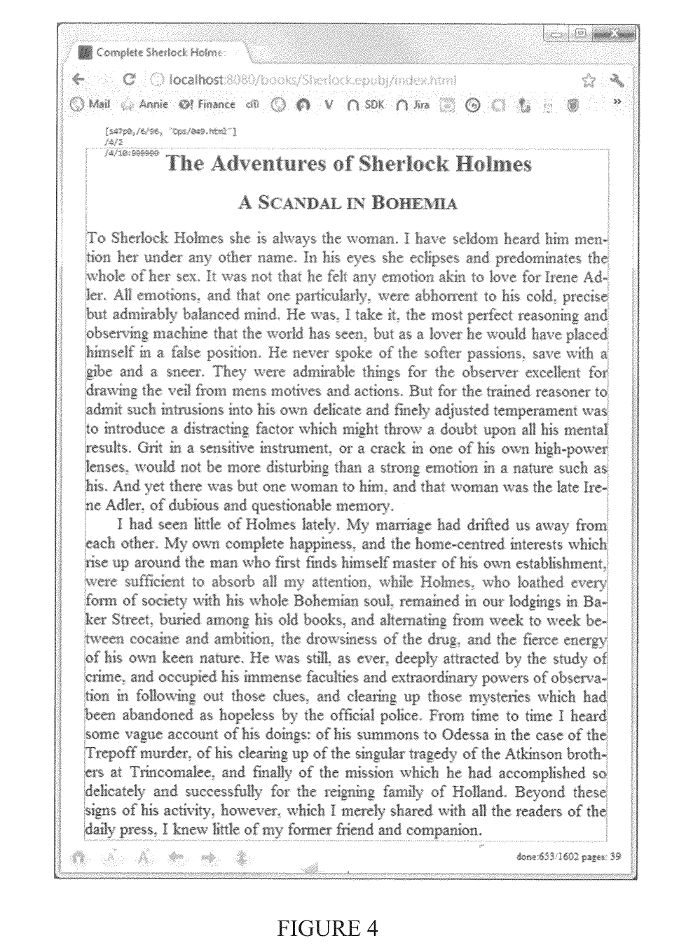

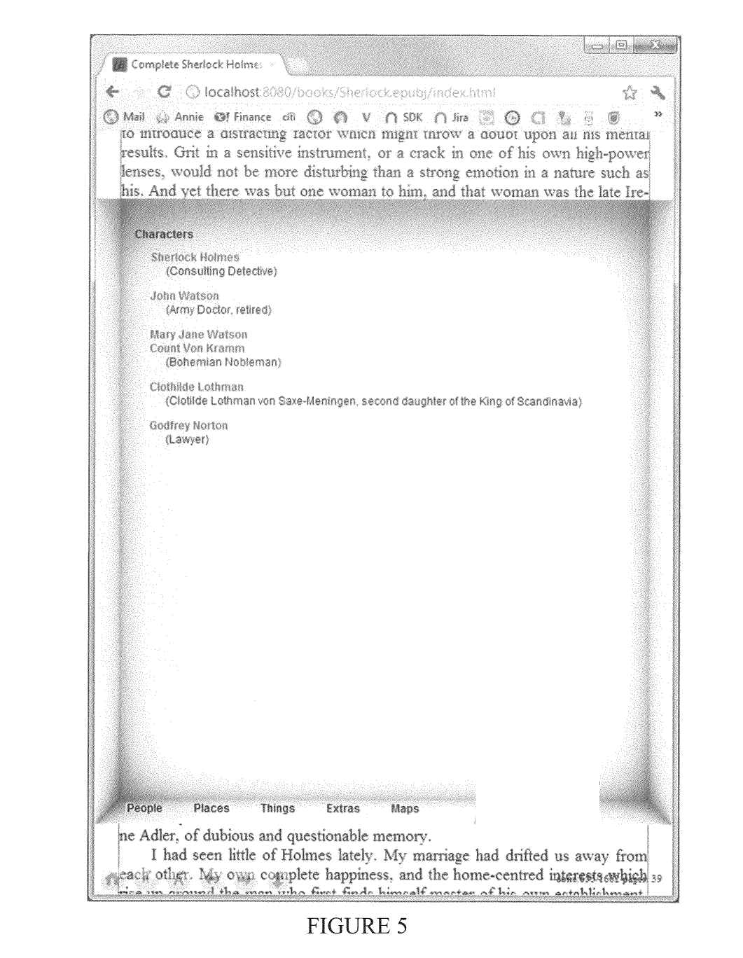

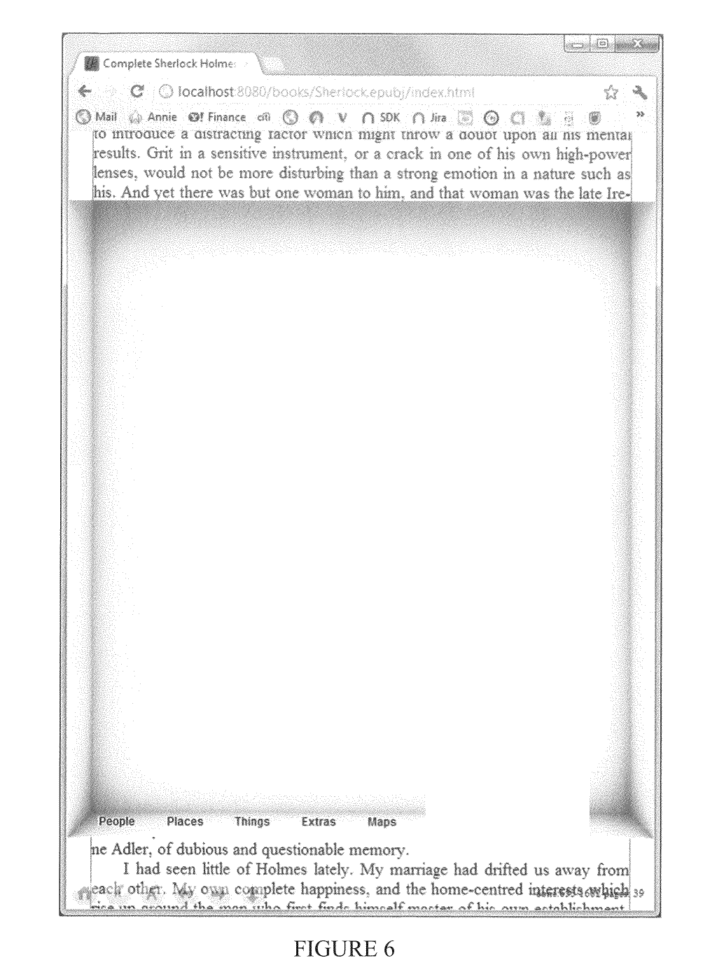

The transition from conventional book view to a new window display is shown from transitioning from FIG. 4 to FIG. 5. Upon detection of the trigger associated with the CFI at that location, a new window is displayed with character information about Sherlock Holmes, etc. Furthermore, a window display could be displayed with a blank screen but highlight an Extras tab (as depicted in FIG. 6).

Table 2 shows two pages of a reference file that is utilized as an index for the auxiliary file depicted in Table 1. As discussed earlier, the reference file, which also may be in an .xml format in one embodiment, is utilized as an index for the auxiliary file. Upon execution of both the reference file and auxiliary file, a trigger could result when an associated CFI is visible on a current page as viewed by the user. Consequently, the present invention initiates or executes a script, or loads a page, displays an image, etc.

In one embodiment, the reference file and auxiliary file are separate files, in contrast, in another embodiment, the information could be combined from both files into a single file. In this specific embodiment, the reference file acts as an index and articulates the specific character information, setting, etc. and associated CFIs to facilitate the trigger point and displaying of the information as previously discussed.

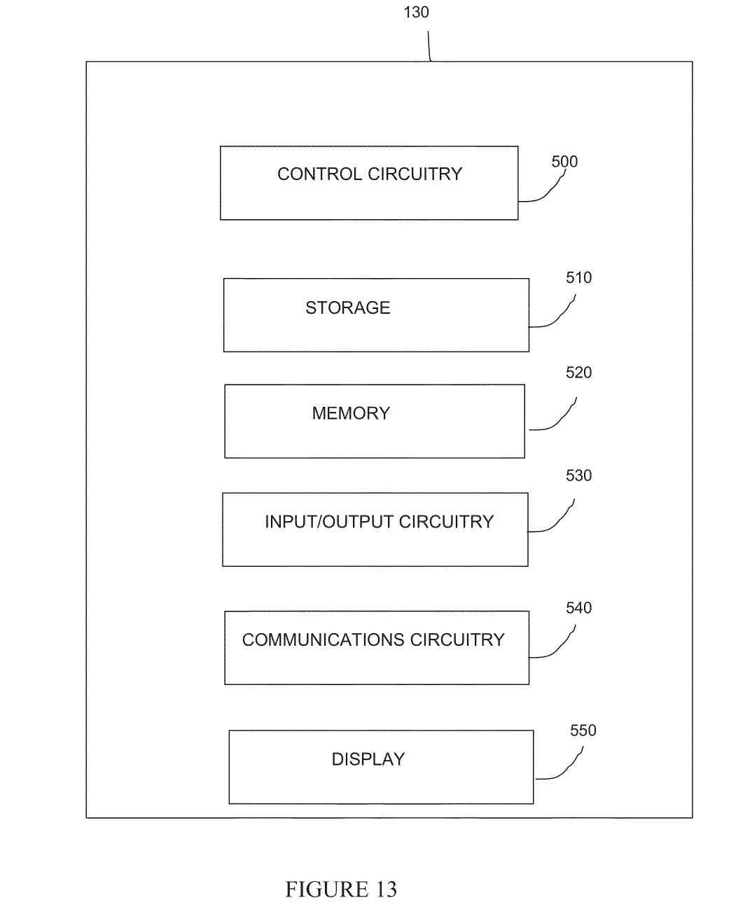

FIG. 13 illustrates an exemplary electronic device 130 on which the present invention can operate. As appreciated by those skilled the art, the local device 130 can take many forms capable of operating the present invention. In a preferred embodiment the local device 130 is a mobile electronic device, and in an even more preferred embodiment device 130 is an electronic reader device. Electronic device 130 can include control circuitry 500, storage 510, memory 520, input/output (“I/O”) circuitry 530, communications circuitry 540, and display 550. In some embodiments, one or more of the components of electronic device 130 can be combined or omitted, e.g., storage 510 and memory 520 may be combined. As appreciated by those skilled in the art, electronic device 130 can include other components not combined or included in those shown in this Figure, e.g., a power supply such as a battery, an input mechanism, etc.

Electronic device 130 can include any suitable type of electronic device. For example, electronic device 130 can include a portable electronic device that the user may hold in his or her hand, such as a digital media player, a personal e-mail device, a personal data assistant (“PDA”), a cellular telephone, a handheld gaming device, a tablet device or an eBook reader. As another example, electronic device 130 can include a larger portable electronic device, such as a laptop computer. As yet another example, electronic device 130 can include a substantially fixed electronic device, such as a desktop computer.

Control circuitry 500 can include any processing circuitry or processor operative to control the operations and performance of electronic device 130. For example, control circuitry 500 can be used to run operating system applications, firmware applications, media playback applications, media editing applications, or any other application. Control circuitry 500 can drive the display 550 and process inputs received from a user interface, e.g., the display 550 if it is a touch screen.

Storage 510 can include, for example, one or more tangible, non-transitory computer storage mediums including a hard-drive, solid state drive, flash memory, permanent memory such as ROM, magnetic, optical, semiconductor, paper, or any other suitable type of storage component, or any combination thereof. Storage 510 can store, for example, media content, e.g., eBooks, music and video files, application data, e.g., software for implementing functions on electronic device 130, firmware, user preference information data, e.g., content preferences, authentication information, e.g., libraries of data associated with authorized users, transaction information data, e.g., information such as credit card information, wireless connection information data, e.g., information that can enable electronic device 130 to establish a wireless connection), subscription information data, e.g., information that keeps track of podcasts or television shows or other media a user subscribes to, contact information data, e.g., telephone numbers and email addresses, calendar information data, and any other suitable data or any combination thereof. The instructions for implementing the functions of the present invention may, as non-limiting examples, comprise software and/or scripts stored in the computer-readable media 510.

Memory 520 can include cache memory, semi-permanent memory such as RAM, and/or one or more different types of memory used for temporarily storing data. In some embodiments, memory 520 can also be used for storing data and instructions used to operate electronic device applications, or any other type of data that can be stored in storage 510. In some embodiments, memory 520 and storage 510 can be combined as a single storage medium.

I/O circuitry 530 can be operative to convert, and encode/decode, if necessary analog signals and other signals into digital data. In some embodiments, I/O circuitry 530 can also convert digital data into any other type of signal, and vice-versa. For example, I/O circuitry 530 can receive and convert physical contact inputs, e.g., from a multi-touch screen, i.e., display 550, physical movements, e.g., from a mouse or sensor, analog audio signals, e.g., from a microphone, or any other input. The digital data can be provided to and received from control circuitry 500, storage 510, and memory 520, or any other component of electronic device 130. Although I/O circuitry 530 is illustrated in this Figure as a single component of electronic device 130, several instances of I/O circuitry 530 can be included in electronic device 130.

Electronic device 130 can include any suitable interface or component for allowing a user to provide inputs to I/O circuitry 530. For example, electronic device 130 can include any suitable input mechanism, such as a button, keypad, dial, a click wheel, or a touch screen, e.g., display 550. In some embodiments, electronic device 130 can include a capacitive sensing mechanism, or a multi-touch capacitive sensing mechanism.

In some embodiments, electronic device 130 can include specialized output circuitry associated with output devices such as, for example, one or more audio outputs. The audio output can include one or more speakers, e.g., mono or stereo speakers, built into electronic device 130, or an audio component that is remotely coupled to electronic device 130, e.g., a headset, headphones or earbuds that can be coupled to device 130 with a wire or wirelessly.

Display 550 includes the display and display circuitry for providing a display visible to the user. For example, the display circuitry can include a screen, e.g., an LCD screen, that is incorporated in electronics device 130. In some embodiments, the display circuitry can include a coder/decoder (Codec) to convert digital media data into analog signals. For example, the display circuitry or other appropriate circuitry within electronic device 1 can include video Codecs, audio Codecs, or any other suitable type of Codec.

The display circuitry also can include display driver circuitry, circuitry for driving display drivers, or both. The display circuitry can be operative to display content, e.g., media playback information, application screens for applications implemented on the electronic device 130, information regarding ongoing communications operations, information regarding incoming communications requests, or device operation screens, under the direction of control circuitry 500. Alternatively, the display circuitry can be operative to provide instructions to a remote display.

Communications circuitry 540 can include any suitable communications circuitry operative to connect to a communications network and to transmit communications, e.g., data from electronic device 130 to other devices within the communications network. Communications circuitry 540 can be operative to interface with the communications network using any suitable communications protocol such as, for example, e.g., a 802.1 protocol, Bluetooth, radio frequency systems, e.g., 900 MHz, 1.4 GHz, and 5.6 GHz communication systems, infrared, GSM, GSM plus EDGE, CDMA, quadband, and other cellular protocols, VOIP, or any other suitable protocol.

Electronic device 130 can include one more instances of communications circuitry 540 for simultaneously performing several communications operations using different communications networks, although only one is shown in this Figure to avoid overcomplicating the drawing. For example, electronic device 130 can include a first instance of communications circuitry 540 for communicating over a cellular network, and a second instance of communications circuitry 540 for communicating over Wi-Fi or using Bluetooth. In some embodiments, the same instance of communications circuitry 540 can be operative to provide for communications over several communications networks.

In some embodiments, electronic device 130 can be coupled to a host device such as digital content control server 150 for data transfers, synching the communications device, software or firmware updates, providing performance information to a remote source, e.g., providing riding characteristics to a remote server, or performing any other suitable operation that can require electronic device 130 to be coupled to a host device. Several electronic devices 130 can be coupled to a single host device using the host device as a server. Alternatively or additionally, electronic device 130 can be coupled to several host devices, e.g., for each of the plurality of the host devices to serve as a backup for data stored in electronic device 130.

Although the present invention has been described in relation to particular embodiments thereof, many other variations and other uses will be apparent to those skilled in the art. It is preferred, therefore, that the present invention be limited not by the specific disclosure herein, but only by the gist and scope of the disclosure.

What is claimed is:

1. A method for executing electronic book content on an electronic device having a display screen on which one or more pages of content is displayed, the method comprising:
storing, in a memory on the electronic device, a book file, an auxiliary file containing entity details and at least trigger based on a reference to a CFI, and a reference file that contains an index to the auxiliary file, wherein the auxiliary file and the reference file are associated with the book file;
executing the book file on the electronic device;
utilizing the reference file as an index for the auxiliary file;
examining the auxiliary file and the reference file during the execution of the book file; and
executing the trigger when an associated CFI is visible on a current page as viewed by a user.

2. The method of claim 1, wherein the book file is in EPUB format and allows for a script or execution of an event based on the trigger that results in a window display near a trigger point.

3. The method of claim 2, wherein there is a separate auxiliary file and a separate reference file.

4. The method of claim 1, wherein the auxiliary file and the reference file are in .xml format.

5. The method of claim 1, wherein executing the trigger to reach a result page includes facilitating at least one of:
executing a script;
loading a page;
playing a video underlay or overlay;
animating via means other than scripting; and
fading a content page in or out.

6. A system for executing electronic book content on electronic device, the system comprising:
a display screen
a memory that includes a book file, an auxiliary file containing entity details and at least trigger based on a reference to a Canonical Fragment Identifier, CFI, a reference file that contains an index to the auxiliary file, and instructions; and
control circuitry coupled to the memory and coupled to the display screen; the control circuitry operable to execute the instructions in memory to at least:
execute the book file,
utilize the reference file as an index for the auxiliary file during the execution of the book file,
examine the auxiliary file and the reference file during the execution of the book file,
executing the trigger when an associated CFI is visible on a current page as viewed by a user,
display the one or more pages of the content on the display screen of the electronic book device so that the content fills an entire display area of the display screen, and
display results of the executed trigger when an associated CFI is visible on a current page to initiate or run a script to load a page and display.

7. The system of claim 6, wherein the book file is in EPUB format and allows for a script or execution of an event based on the trigger that results in a window display near a trigger point.

8. The system of claim 7, wherein there is a separate auxiliary file and a separate reference file.

9. The system of claim 6, wherein the auxiliary file and the reference file are in .xml format.

10. The system of claim 6, wherein the act of executing the trigger to reach a result page includes facilitates at least one of:
executing a script;
loading a page;
playing a video underlay or overlay;
animating via means other than scripting; and
fading a content page in or out.

11. A non-transitory computer-readable medium comprising a plurality of instructions that, when executed by at least one electronic device, at least cause the at least one electronic device to:
execute a book file;
utilize a reference file as an index for an auxiliary file during the execution of the book file, the auxiliary file containing entity details and at least trigger based on a reference to a CFI
examine the auxiliary file and the reference file during the execution of the book file,
executing the trigger when an associated CFI is visible on a current page as viewed by a user,
display the one or more pages of the content on the display screen of the electronic book device so that the content fills an entire display area of the display screen, and
display results of the executed trigger when an associated CFI is visible on a current page to initiate or run a script to load a page and display.
